(19) United States
(12) Patent Application Publication
(10) Pub. No.: US 2025/0138293 A1
(43) Pub. Date: May 1, 2025

(54) OPTICAL SYSTEM, DISPLAY DEVICE, AND HEAD-MOUNTED DEVICE

(71) Applicant: Sharp Display Technology Corporation, Kameyama City (JP)

(72) Inventor: Naru USUKURA, Kameyama City (JP)

(21) Appl. No.: 18/890,907

(22) Filed: Sep. 20, 2024

(30) Foreign Application Priority Data
Oct. 27, 2023 (JP) 2023-184548

(51) Int. Cl. G02B 17/00; G02B 5/30; G02B 17/08; G02B 27/01; G06F 1/16

(52) U.S. Cl. CPC G02B 17/008; G02B 5/3025; G02B 17/08; G02B 27/0172; G06F 1/163

(57) ABSTRACT

An optical system includes a half mirror; a first at least one optical element including a first film-shaped optical element to be attached to a first plane; a second at least one optical element including a second film-shaped optical element to be attached to a second plane, disposed at a position symmetric to a position at which the first at least one optical element is disposed with respect to the half mirror, and having a shape symmetric to a shape of the first at least one optical element with respect to the half mirror; and a convex lens.

### CROSS-REFERENCE TO RELATED APPLICATIONS

This application claims the benefit of priority to Japanese Patent Application Number 2023-184548 filed on Oct. 27, 2023. The entire contents of the above-identified application are hereby incorporated by reference.

### BACKGROUND

### Technical Field

The disclosure relates to an optical system, a display device, and a head-mounted device.

WO 2021/200428 discloses an optical element. In the optical element, first linearly-polarized light passes through a first reflective linear polarizer and passes through a first phase difference plate to be changed into right handed circularly-polarized light. Part of the right handed circularly-polarized light is reflected by a partial reflection mirror to be changed into left handed circularly-polarized light. Part of the right handed circularly-polarized light passes through the partial reflection mirror.

The left handed circularly-polarized light reflected by the partial reflection mirror passes through the first phase difference plate to be changed into second linearly-polarized light. The second linearly-polarized light is reflected by the first reflective linear polarizer, and passes through the first phase difference plate to be changed into left handed circularly-polarized light. The left handed circularly-polarized light passes through the partial reflection mirror, and passes through a second phase difference plate to be changed into second linearly-polarized light. The second linearly-polarized light passes through a second reflective linear polarizer.

The right handed circularly-polarized light transmitted through the partial reflection mirror passes through the second phase difference plate to be changed into first linearly-polarized light. The first linearly-polarized light is reflected by the second reflective linear polarizer, and passes through the second phase difference plate to be changed into right handed circularly-polarized light. The right handed circularly-polarized light is reflected by the partial reflection mirror to be changed into left handed circularly-polarized light. The left handed circularly-polarized light passes through the second phase difference plate to be changed into second linearly-polarized light. The second linearly-polarized light passes through the second reflective linear polarizer.

Thus, the optical path length can be increased, and the optical element can be miniaturized (paragraphs [0016] and [0026] to [0036]).

### SUMMARY

A reflective linear polarizer is generally a film-shaped optical element and is attached to a lens surface.

When a reflective linear polarizer is attached to a convex lens surface in the optical element disclosed in WO 2021/200428, an attaching apparatus able to attach the film-shaped optical element to the convex lens surface is required. Because of this, the cost required for equipment for manufacturing the optical element increases. When the reflective linear polarizer is attached to the convex lens surface in the optical element disclosed in WO 2021/200428, problems such as air bubbles being trapped between the reflective linear polarizer and the convex lens surface, and a wrinkle, sag, or the like being produced in the reflective linear polarizer are likely to occur. Therefore, the yield of the optical element is lowered and the cost required to manufacture the optical element is increased. On the other hand, when the reflective linear polarizer is attached to a flat lens surface in the optical element disclosed in WO 2021/200428, positive power of the optical element is insufficient.

In light of the above problems, an aspect of the disclosure has been conceived. An object of an aspect of the disclosure is, for example, to provide an optical system that can be reduced in size, is low in manufacturing cost, and has large positive power, and to provide a display device and a head-mounted device including the optical system mentioned above.

An optical system according to a first aspect of the disclosure includes:
a half mirror having a first surface and a second surface on mutually opposite sides;
a first at least one optical element that includes a first film-shaped optical element to be attached to a first plane and has a third surface and a fourth surface on mutually opposite sides, the third surface facing the first surface, first circularly-polarized light having a first rotation direction being emitted from the third surface in a case where first linearly-polarized light having a first polarization direction is incident on the fourth surface, third circularly-polarized light having the second rotation direction being emitted from the third surface in a case where second circularly-polarized light having the second rotation direction different from the first rotation direction is incident on the third surface;
a second at least one optical element that is disposed at a symmetric position to a position at which the first at least one optical element is disposed with respect to the half mirror, has a symmetric shape to a shape of the first at least one optical element with respect to the half mirror, includes a second film-shaped optical element to be attached to a second plane, and has a fifth surface and a sixth surface on mutually opposite sides, the fifth surface facing the second surface, fifth circularly-polarized light having the first polarization direction being emitted from the fifth surface in a case where fourth circularly-polarized light having the first rotation direction is incident on the fifth surface, second linearly-polarized light having a second polarization direction perpendicular to the first polarization direction being emitted from the sixth surface in a case where sixth circularly-polarized light having the second rotation direction is incident on the fifth surface; and
a convex lens configured to transmit the second linearly-polarized light.

A display device according to a second aspect of the disclosure includes the optical system according to the first aspect of the disclosure and a display configured to emit the first linearly-polarized light.

A head-mounted device according to a third aspect of the disclosure includes the display device according to the second aspect of the disclosure.

### BRIEF DESCRIPTION OF DRAWINGS

The disclosure will be described with reference to the accompanying drawings, wherein like numbers reference like elements.

FIG. 1 is a front view schematically illustrating a head-mounted device according to a first embodiment and a human head on which the head-mounted device is mounted.

FIG. 2 is a cross-sectional view schematically illustrating a display device included in the head-mounted device according to the first embodiment.

FIG. 3 is a diagram illustrating a change in a polarization state in the display device included in the head-mounted device according to the first embodiment.

FIG. 4 is a diagram illustrating a relationship between a first transmission axis and a first reflection axis of a first reflective polarizer included in the head-mounted device, and a relationship between a second transmission axis and a second reflection axis of a second reflective polarizer included in the head-mounted device according to the first embodiment.

FIG. 5 is a diagram illustrating a relationship between a first fast axis and a first slow axis of a first quarter wavelength plate included in the head-mounted device, and a relationship between a second fast axis and a second slow axis of a second quarter wavelength plate included in the head-mounted device according to the first embodiment.

FIG. 6 is a cross-sectional view schematically illustrating a display device included in a head-mounted device according to a second embodiment.

FIG. 7 is a cross-sectional view schematically illustrating a display device included in a head-mounted device according to a third embodiment.

FIG. 8 is a diagram illustrating a relationship between a first turning direction of a first cholesteric liquid crystal film included in the head-mounted device and a second turning direction of a second cholesteric liquid crystal film included in the head-mounted device according to the third embodiment, and a relationship between a first turning direction of a first polarized volume hologram (PVH) film included in a head-mounted device according to a fourth embodiment and a second turning direction of a second PVH film included in the head-mounted device.

FIG. 9 is a cross-sectional view schematically illustrating a display device included in the head-mounted device according to the fourth embodiment.

FIG. 10 is a cross-sectional view schematically illustrating a display device included in a head-mounted device according to a fifth embodiment.

FIG. 11 is a cross-sectional view schematically illustrating a display device included in a head-mounted device according to a sixth embodiment.

FIG. 12 is a cross-sectional view schematically illustrating a display device included in a head-mounted device according to a seventh embodiment.

FIG. 13 is a cross-sectional view schematically illustrating a display device included in a head-mounted device according to an eighth embodiment.

FIG. 14 is a cross-sectional view schematically illustrating a display device included in a head-mounted device according to a ninth embodiment.

FIG. 15 is a cross-sectional view schematically illustrating a display device according to a first reference example.

FIG. 16 is a diagram illustrating a change in a polarization state in the display device according to the first reference example.

FIG. 17 is a cross-sectional view schematically illustrating a display device according to a second reference example.

FIG. 18 is a diagram illustrating a change in a polarization state in the display device according to the second reference example.

### DESCRIPTION OF EMBODIMENTS

With reference to the drawings, embodiments of the disclosure will be described below. Note that, in the drawings, identical or equivalent elements are given an identical reference sign, and redundant descriptions thereof may be omitted.

### 1. First Reference Example

Hereinafter, a display device of a first reference example will be described in order to facilitate understanding of a display device included in a head-mounted device of a first embodiment.

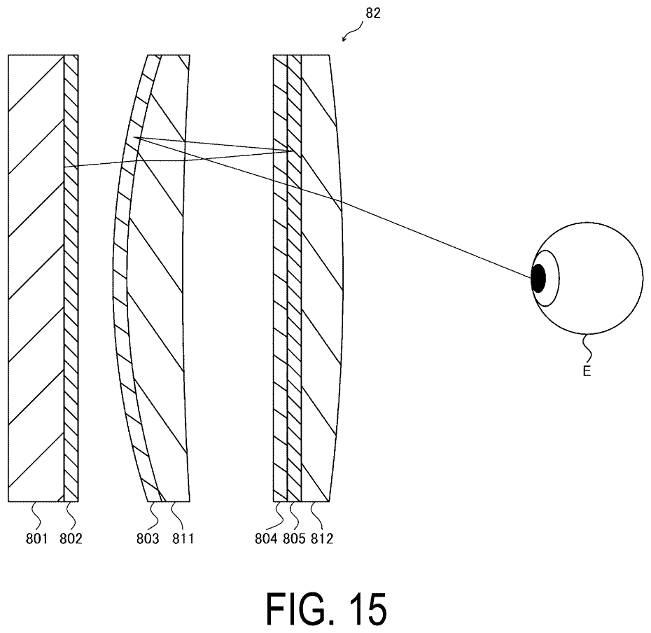

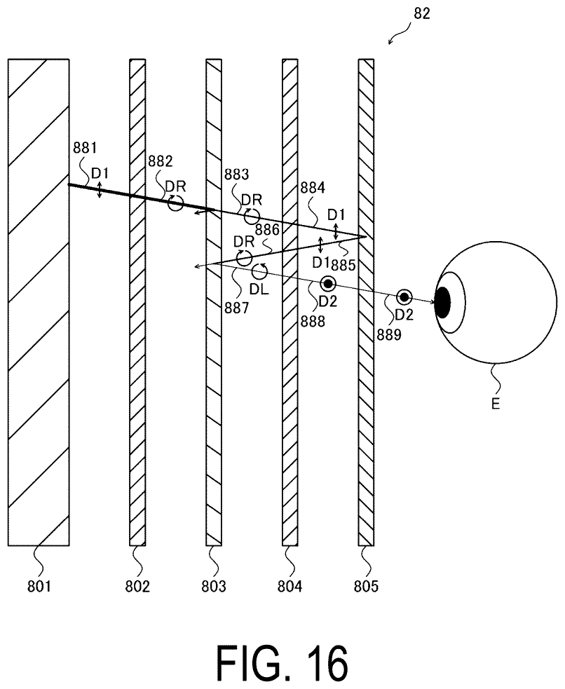

FIG. 15 is a cross-sectional view schematically illustrating a display device of the first reference example. FIG. 16 is a diagram illustrating a change in a polarization state in a display device of the first reference example.

A display device 82 of the first reference example illustrated in FIGS. 15 and 16 includes a thin pancake lens. In the pancake lens, a single pass method is adopted in which light is guided to the eye E via one optical path.

As illustrated in FIGS. 15 and 16, the display device 82 includes a display 801, a quarter wavelength plate 802, a half mirror 803, a quarter wavelength plate 804, and a reflective polarizer 805.

The display 801, the quarter wavelength plate 802, the half mirror 803, the quarter wavelength plate 804, and the reflective polarizer 805 are arrayed in a row in the described order.

The display 801 emits linearly-polarized light 881 having a first polarization direction D1.

The quarter wavelength plate 802 transmits the linearly-polarized light 881 and emits circularly-polarized light 882 having a first rotation direction DR.

The half mirror 803 transmits part of the circularly-polarized light 882 and emits circularly-polarized light 883 having the first rotation direction DR.

The quarter wavelength plate 804 transmits the circularly-polarized light 883 and emits linearly-polarized light 884 having the first polarization direction D1.

The reflective polarizer 805 reflects the linearly-polarized light 884 and emits linearly-polarized light 885 having the first polarization direction D1.

The quarter wavelength plate 804 transmits the linearly-polarized light 885 and emits circularly-polarized light 886 having the first rotation direction DR.

The half mirror 803 reflects part of the circularly-polarized light 886 and emits circularly-polarized light 887 having a second rotation direction DL.

The quarter wavelength plate 804 transmits the circularly-polarized light 887 and emits linearly-polarized light 888 having a second polarization direction D2.

The reflective polarizer 805 transmits the linearly-polarized light 888 and emits linearly-polarized light 889 having the second polarization direction D2.

The linearly-polarized light 889 reaches the eye E.

In the display device 82, light reciprocates between the half mirror 803 and the reflective polarizer 805. This makes it possible to lengthen an optical path of the light. Thus, an optical system including the quarter wavelength plate 802, the half mirror 803, the quarter wavelength plate 804, and the reflective polarizer 805 forms the thin pancake lens.

In the display device 82, the half mirror 803 reflects part of the circularly-polarized light 882, thereby losing about 50% of the amount of light. Further, since the half mirror 803 transmits part of the circularly-polarized light 886, about 25% of the amount of light is lost. Thus, in total, about 75% of the amount of light is lost.

As illustrated in FIG. 15, the display device 82 includes a lens 811 and a lens 812. The quarter wavelength plate 802 is attached to a display surface of the display 801. The half mirror 803 is attached to a convex lens surface of the lens 811. The quarter wavelength plate 804 and the reflective polarizer 805 are attached to a flat lens surface of the lens 812.

### 2. Second Reference Example

Hereinafter, a display device of a second reference example will be described in order to facilitate understanding of a display device included in a head-mounted device of the first embodiment.

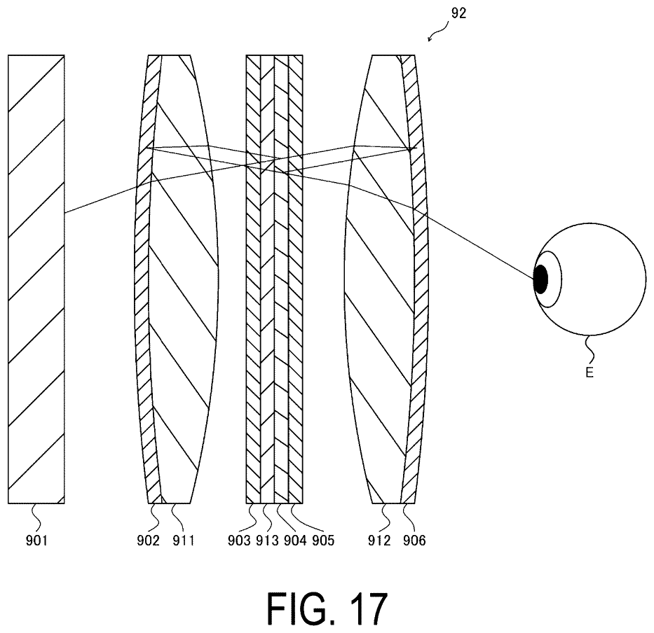

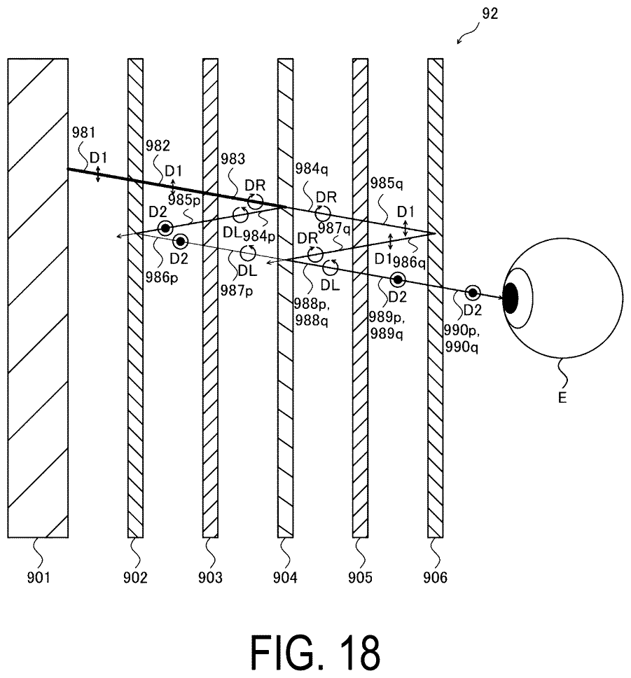

FIG. 17 is a cross-sectional view schematically illustrating a display device according to the second reference example. FIG. 18 is a diagram illustrating a change in a polarization state in a display device according to the second reference example.

A display device 92 of the second reference example illustrated in FIGS. 17 and 18 includes a thin pancake lens. In the pancake lens, a double pass method is adopted in which light is guided to the eye E via two optical paths different from each other.

As illustrated in FIGS. 17 and 18, the display device 92 includes a display 901, a reflective polarizer 902, a quarter wavelength plate 903, a half mirror 904, a quarter wavelength plate 905, and a reflective polarizer 906.

The display 901, the reflective polarizer 902, the quarter wavelength plate 903, the half mirror 904, the quarter wavelength plate 905, and the reflective polarizer 906 are arrayed in a row in the described order.

The display 901 emits linearly-polarized light 981 having the first polarization direction D1.

The reflective polarizer 902 transmits the linearly-polarized light 981 and emits linearly-polarized light 982 having the first polarization direction D1.

The quarter wavelength plate 903 transmits the linearly-polarized light 982 and emits circularly-polarized light 983 having the first rotation direction DR.

The half mirror 904 reflects part of the circularly-polarized light 983 and emits circularly-polarized light 984p having the second rotation direction DL. Further, the half mirror 904 transmits part of the circularly-polarized light 983 and emits circularly-polarized light 984q having the first rotation direction DR.

The quarter wavelength plate 903 transmits the circularly-polarized light 984p and emits linearly-polarized light 985p having the second polarization direction D2.

The reflective polarizer 902 reflects the linearly-polarized light 985p and emits linearly-polarized light 986p having the second polarization direction D2.

The quarter wavelength plate 903 transmits the linearly-polarized light 986p and emits circularly-polarized light 987p having the second rotation direction DL.

The half mirror 904 transmits part of the circularly-polarized light 987p and emits circularly-polarized light 988p having the second rotation direction DL.

The quarter wavelength plate 905 transmits the circularly-polarized light 988p and emits linearly-polarized light 989p having the second polarization direction D2.

The reflective polarizer 906 transmits the linearly-polarized light 989p and emits linearly-polarized light 990p having the second polarization direction D2.

The quarter wavelength plate 905 transmits the circularly-polarized light 984q and emits linearly-polarized light 985q having the first polarization direction D1.

The reflective polarizer 906 reflects the linearly-polarized light 985q and emits linearly-polarized light 986q having the first polarization direction D1.

The quarter wavelength plate 905 transmits the linearly-polarized light 986q and emits circularly-polarized light 987q having the first rotation direction DR.

The half mirror 904 reflects part of the circularly-polarized light 987q and emits circularly-polarized light 988q having the second rotation direction DL.

The quarter wavelength plate 905 transmits the circularly-polarized light 988q and emits linearly-polarized light 989q having the second polarization direction D2.

The reflective polarizer 906 transmits the linearly-polarized light 989q and emits linearly-polarized light 990q having the second polarization direction D2.

Linearly-polarized light 890p and linearly-polarized light 890q reach the eye E.

The reflective polarizer 902, the quarter wavelength plate 903, the half mirror 904, the quarter wavelength plate 905, and the reflective polarizer 906 are designed to be symmetric with respect to the half mirror 904. This makes it possible to suppress a situation in which the image formed on the eye E becomes a double image.

In the display device 92, part of light reciprocates between the half mirror 904 and the reflective polarizer 902. Further, part of the light reciprocates between the half mirror 904 and the reflective polarizer 906. This makes it possible to lengthen an optical path of the light. Thus, an optical system including the reflective polarizer 902, the quarter wavelength plate 903, the half mirror 904, the quarter wavelength plate 905, and the reflective polarizer 906 forms the thin pancake lens.

In the display device 92, the half mirror 904 reflects part of the circularly-polarized light 987q, thereby losing about 25% of the amount of light. Further, since the reflective polarizer 902 transmits part of the linearly-polarized light 985p, about 25% of the amount of light is lost. Thus, in total, about 50% of the amount of light is lost. Therefore, the amount of light lost in the display device 92 is less than the amount of light lost in the display device 82.

As illustrated in FIG. 17, the display device 92 includes a lens 911, a lens 912, and a glass plate 913. The reflective polarizer 902 is attached to a convex lens surface of the lens 911. The quarter wavelength plate 903, the half mirror 904, and the quarter wavelength plate 905 are attached to main surfaces of the glass plate 913. The reflective polarizer 906 is attached to a convex lens surface of the lens 912. It is sufficient for the quarter wavelength plate 903 to be disposed between the half mirror 904 and the reflective polarizer 902. Therefore, the quarter wavelength plate 903 may be attached to a convex lens surface of the lens 911. It is sufficient for the quarter wavelength plate 905 to be disposed between the half mirror 904 and the reflective polarizer 906. Therefore, the quarter wavelength plate 905 may be attached to a convex lens surface of the lens 912.

In the display device 92, the reflective polarizers 902 and 906 are attached to the convex lens surfaces of the lenses 911 and 912, respectively. Thus, an attaching apparatus able to attach a film-shaped optical element to a convex lens surface is required. Because of this, the cost required for equipment for manufacturing the display device 92 increases. In addition, problems such as air bubbles being trapped between the reflective polarizer 902 and the lens 911, air bubbles being trapped between the reflective polarizer 906 and the lens 912, a wrinkle, sag, or the like being produced in the reflective polarizer 902, and a wrinkle, sag, or the like being produced in the reflective polarizer 906 may occur. Therefore, the yield of the display device 92 is lowered and the cost required to manufacture the display device 92 is increased.

### 3. First Embodiment

### 3.1 Head-Mounted Device

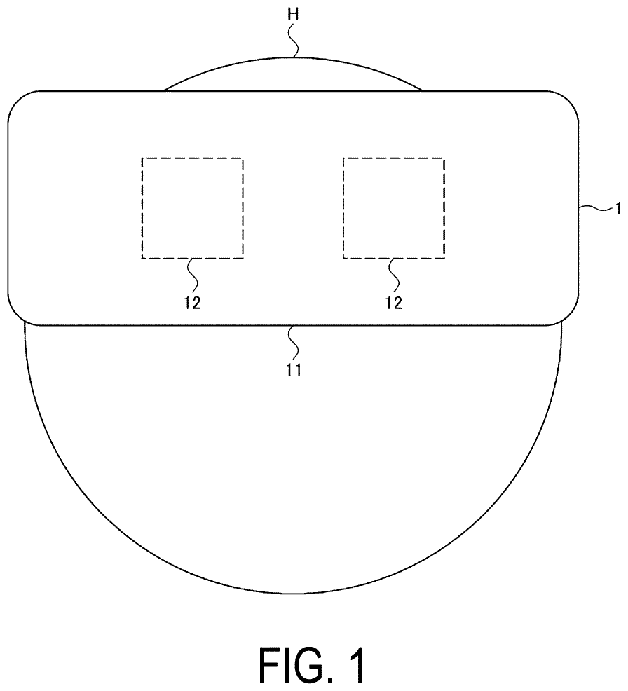

FIG. 1 is a front view schematically illustrating a head-mounted device according to a first embodiment and a human head on which the head-mounted device is mounted.

A head-mounted device 1 illustrated in FIG. 1 is mounted on the head H of a person. The head-mounted device 1 is a goggle-type head-mounted device. The head-mounted device 1 may be a head-mounted device other than the goggle-type head-mounted device. For example, the head-mounted device 1 may be a head-mounted device of a headset type, an eyeglass type, or the like.

The head-mounted device 1 displays a virtual reality (VR) image. The head-mounted device 1 may display an image other than the VR image. For example, the head-mounted device 1 may display an augmented reality (AR) image, a mixed reality (MR) image, or the like.

As illustrated in FIG. 1, the head-mounted device 1 includes a housing 11 and a display device 12.

The housing 11 can be mounted on and dismounted from the head H. The housing 11 accommodates the display device 12.

The display device 12 faces the eyes present at the head H. The display device 12 displays an image toward the eyes facing the device.

### 3.2 Display Device

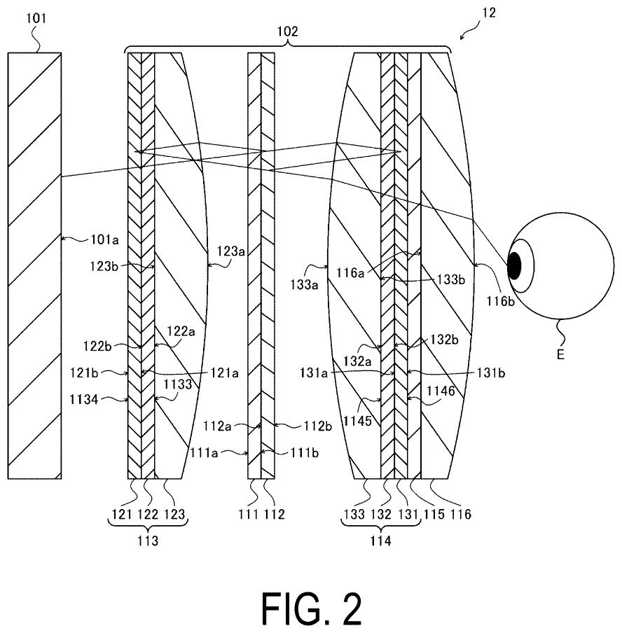

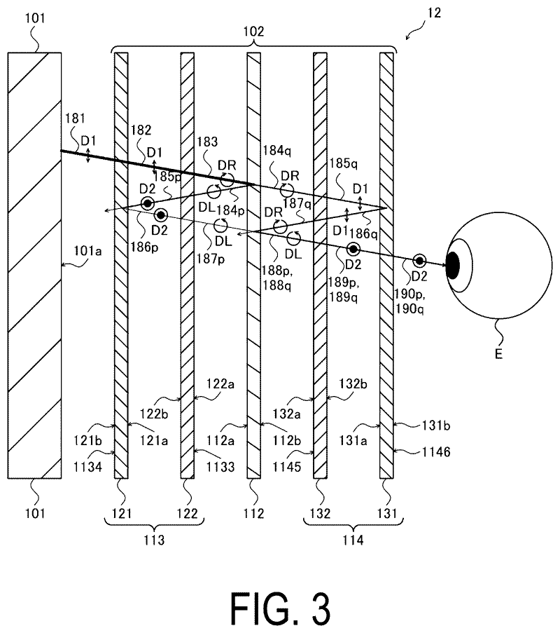

FIG. 2 is a cross-sectional view schematically illustrating a display device included in the head-mounted device according to the first embodiment. FIG. 3 is a diagram illustrating a change in a polarization state in the display device included in the head-mounted device according to the first embodiment.

The display device 12 illustrated in FIGS. 2 and 3 includes a thin pancake lens. In the pancake lens, the double pass method is adopted in which light is guided to the eye E via two optical paths.

As illustrated in FIG. 2, the display device 12 includes a display 101 and an optical system 102.

The display 101 emits first linearly-polarized light (linearly-polarized light 181). The display 101 emits the first linearly-polarized light (linearly-polarized light 181) having a distribution of luminance and chromaticity corresponding to an input image signal. With this, the display 101 displays an image corresponding to the input image signal. The display 101 has a display surface 101a. The display 101 displays an image on the display surface 101a. The display 101 is a liquid crystal display (LCD), a self-emitting display, or the like.

The optical system 102 focuses light emitted by the display 101 on the eye E. Thus, the optical system 102 forms an image corresponding to the image displayed by the display 101, on the eye E.

### 3.3 Optical System

As illustrated in FIGS. 2 and 3, the optical system 102 includes a transparent plate 111, a half mirror 112, a first at least one optical element 113, a second at least one optical element 114, a polarizer 115, and a convex lens 116.

The transparent plate 111 is disposed between the first at least one optical element 113 and the second at least one optical element 114. The transparent plate 111 is disposed between a first convex lens surface 123a of a first lens 123 of the first at least one optical element 113 and a second convex lens surface 133a of a second lens 133 of the second at least one optical element 114.

The transparent plate 111 has one main surface 111a and the other main surface 111b. The one main surface 111a and the other main surface 111b are present on mutually opposite sides.

The transparent plate 111 is a glass plate or the like.

The half mirror 112 is disposed on the other main surface 111b of the transparent plate 111. The half mirror 112 may be disposed on the one main surface 111a of the transparent plate 111.

The half mirror 112 has a first surface 112a and a second surface 112b. The first surface 112a and the second surface 112b are present on mutually opposite sides.

The first at least one optical element 113 has a third surface 1133 and a fourth surface 1134. The third surface 1133 faces the first surface 112a of the half mirror 112. The fourth surface 1134 faces the display surface 101a of the display 101.

When the first linearly-polarized light (linearly-polarized light 181) having the first polarization direction D1 is incident on the fourth surface 1134, the first at least one optical element 113 transmits the incident first linearly-polarized light (linearly-polarized light 181) and emits first circularly-polarized light (circularly-polarized light 183) having the first rotation direction DR from the third surface 1133. When second circularly-polarized light (circularly-polarized light 184p) having the second rotation direction DL different from the first rotation direction DR is incident on the third surface 1133, the first at least one optical element 113 reflects the incident second circularly-polarized light (circularly-polarized light 184p) and emits third circularly-polarized light (circularly-polarized light 187p) having the second rotation direction DL from the third surface 1133.

The second at least one optical element 114 has a fifth surface 1145 and a sixth surface 1146. The fifth surface 1145 faces the second surface 112b of the half mirror 112. The sixth surface 1146 faces a third flat lens surface 116a of the convex lens 116.

When fourth circularly-polarized light (circularly-polarized light 184q) having the first rotation direction DR is incident on the fifth surface 1145, the second at least one optical element 114 reflects the incident fourth circularly-polarized light (circularly-polarized light 184q) and emits fifth circularly-polarized light (circularly-polarized light 187q) having the first rotation direction DR from the fifth surface 1145. When sixth circularly-polarized light (circularly-polarized light 188p and 188q) having the second rotation direction DL is incident on the fifth surface 1145, the second at least one optical element 114 transmits the incident sixth circularly-polarized light (circularly-polarized light 188p and 188q) and emits second linearly-polarized light (linearly-polarized light 190p and 190q) having the second polarization direction D2 perpendicular to the first polarization direction D1 from the sixth surface 1146.

Thus, the first at least one optical element 113 transmits the linearly-polarized light 181 having the first polarization direction D1 and emits the circularly-polarized light 183 having the first rotation direction DR.

The half mirror 112 reflects part of the circularly-polarized light 183 and emits the circularly-polarized light 184p having the second rotation direction DL. Further, the half mirror 112 transmits part of the circularly-polarized light 183 and emits the circularly-polarized light 184q having the first rotation direction DR.

The first at least one optical element 113 reflects the circularly-polarized light 184p and emits the circularly-polarized light 187p having the second rotation direction DL.

The half mirror 112 transmits part of the circularly-polarized light 187p and emits the circularly-polarized light 188p having the second rotation direction DL.

The second at least one optical element 114 transmits the circularly-polarized light 188p and emits the linearly-polarized light 190p having the second polarization direction D2.

The second at least one optical element 114 reflects the circularly-polarized light 184q and emits the circularly-polarized light 187q having the first rotation direction DR.

The half mirror 112 reflects part of the circularly-polarized light 187q and emits the circularly-polarized light 188q having the second rotation direction DL.

The second at least one optical element 114 transmits the circularly-polarized light 188q and emits the linearly-polarized light 190q having the second polarization direction D2.

The second at least one optical element 114 is disposed at a symmetric position to a position at which the first at least one optical element 113 is disposed with respect to the half mirror 112. The second at least one optical element 114 has a symmetric shape to a shape of the first at least one optical element 113 with respect to the half mirror 112. Being symmetric with respect to the half mirror 112 means being optically symmetric, and means being symmetric regarding optical characteristics that affect the optical path of light, such as a refractive index distribution. This makes it possible to bring the optical paths of the linearly-polarized light 190p and linearly-polarized light 190q coincident with each other. Accordingly, it is possible to suppress a situation in which an image formed by the first at least one optical element 113, the half mirror 112, and the second at least one optical element 114 becomes a double image.

The polarizer 115 is disposed closer to the eye E than the second at least one optical element 114. With this, the polarizer 115 transmits the linearly-polarized light 190p and 190q. The polarizer 115 suppresses a situation in which reflection light is reflected by a second reflective polarizer 131 included in the second at least one optical element 114 and reaches the eye E of the user. The reflection light is generated by the eye E, the face, or the like of the user reflecting the linearly-polarized light 190p and 190q. Thus, the polarizer 115 improves the quality of the image displayed by the display device 12. The polarizer 115 may be omitted.

The convex lens 116 is disposed closer to the eye E than the polarizer 115 and the second at least one optical element 114. With this, the convex lens 116 transmits the second linearly-polarized light (linearly-polarized light 190p and 190q) transmitted through the polarizer 115. The second linearly-polarized light (linearly-polarized light 190p and 190q) transmitted through the convex lens 116 is guided to the eye E.

The convex lens 116 is disposed outside of the first at least one optical element 113, the half mirror 112, and the second at least one optical element 114, which need to have symmetry. This makes it possible to increase the positive power of the optical system 102, and widen the field of view (FOV) of the optical system 102.

The convex lens 116 is disposed outside of a section between a first reflective polarizer 121 included in the first at least one optical element 113 and the second reflective polarizer 131 included in the second at least one optical element 114; these reflective polarizers perform polarization compensation. Therefore, the convex lens 116 is allowed to be a lens made of a material having residual double refraction.

### 3.4 First At Least One Optical Element

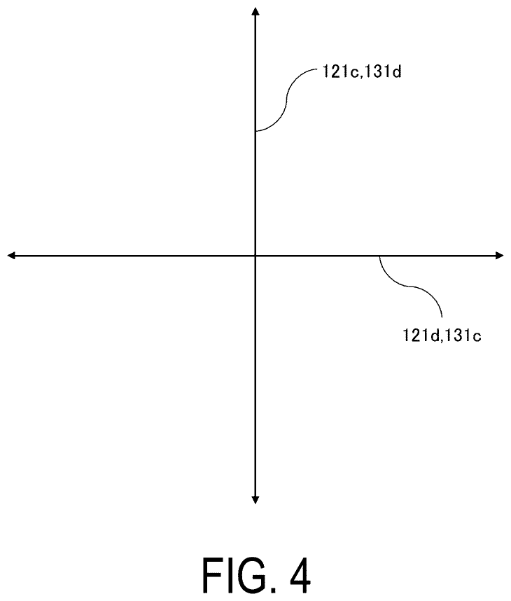

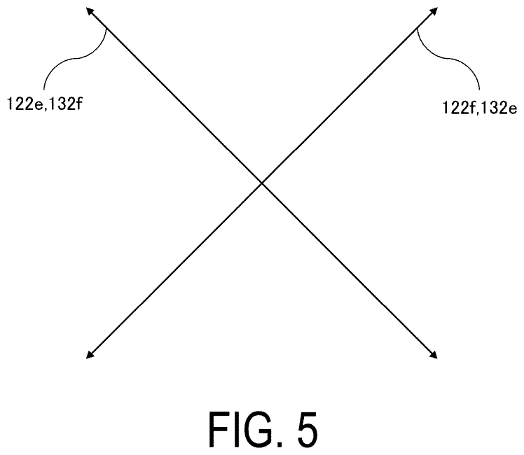

FIG. 4 is a diagram illustrating a relationship between a first transmission axis and a first reflection axis of a first reflective polarizer included in the head-mounted device, and a relationship between a second transmission axis and a second reflection axis of a second reflective polarizer included in the head-mounted device according to the first embodiment. FIG. 5 is a diagram illustrating a relationship between a first fast axis and a first slow axis of a first quarter wavelength plate included in the head-mounted device, and a relationship between a second fast axis and a second slow axis of a second quarter wavelength plate included in the head-mounted device according to the first embodiment.

As illustrated in FIGS. 2 and 3, the first at least one optical element 113 includes the first reflective polarizer 121, a first quarter wavelength plate 122, and the first lens 123.

The first reflective polarizer 121 is a first film-shaped optical element. The first reflective polarizer 121 has a first main surface 121a and a second main surface 121b. The first main surface 121a and the second main surface 121b are present on mutually opposite sides. The second main surface 121b is the fourth surface 1134 of the first at least one optical element 113.

As illustrated in FIG. 4, the first reflective polarizer 121 has a first transmission axis 121c and a first reflection axis 121d. The first transmission axis 121c and the first reflection axis 121d are perpendicular to each other. The first polarization direction D1 is parallel to the first transmission axis 121c. The second polarization direction D2 is parallel to the first reflection axis 121d. Thus, the first reflective polarizer 121 selectively transmits the linearly-polarized light 181 having the first polarization direction D1 and emits linearly-polarized light 182 having the first polarization direction D1. The first reflective polarizer 121 selectively reflects linearly-polarized light 185p having the second polarization direction D2 and emits linearly-polarized light 186p having the second polarization direction D2.

The first quarter wavelength plate 122 is disposed between the half mirror 112 and the first reflective polarizer 121.

The first quarter wavelength plate 122 has a first surface 122a and a second surface 122b. The first surface 122a and the second surface 122b are present on mutually opposite sides. The first surface 122a is the third surface 1133 of the first at least one optical element 113.

As illustrated in FIG. 5, the first quarter wavelength plate 122 has a first fast axis 122e and a first slow axis 122f. The first fast axis 122e and the first slow axis 122f are perpendicular to each other. The first polarization direction D1 forms an angle of 45° with the first fast axis 122e. The second polarization direction D2 forms an angle of 45° with the first fast axis 122e. Thus, the first quarter wavelength plate 122 transmits the linearly-polarized light 182 having the first polarization direction D1 and emits the circularly-polarized light 183 having the first rotation direction DR. Further, the first quarter wavelength plate 122 transmits the circularly-polarized light 184p having the second rotation direction DL and emits the linearly-polarized light 185p having the second polarization direction D2. The first quarter wavelength plate 122 transmits the linearly-polarized light 186p having the second polarization direction D2 and emits the circularly-polarized light 187p having the second rotation direction DL.

Thus, when the linearly-polarized light 181 having the first polarization direction D1 is incident on the fourth surface 1134, the first at least one optical element 113 transmits the incident linearly-polarized light 181 and emits the circularly-polarized light 183 having the first rotation direction DR from the third surface 1133. In addition, when the circularly-polarized light 184p having the second rotation direction DL is incident on the third surface 1133, the first at least one optical element 113 reflects the incident circularly-polarized light 184p and emits the circularly-polarized light 187p having the second rotation direction DL from the third surface 1133.

The first lens 123 is a first plano-convex lens. Due to this, the first lens 123 has positive power. The first lens 123 has the first convex lens surface 123a and a first flat lens surface 123b. The first convex lens surface 123a and the first flat lens surface 123b are present on mutually opposite sides. The first convex lens surface 123a faces the first surface 112a of the half mirror 112. The first convex lens surface 123a may take any of a spherical surface, an aspherical surface, and a free-form surface.

The first reflective polarizer 121 and the first quarter wavelength plate 122 are attached to the first flat lens surface 123b of the first lens 123 as a first plane. With this, the first reflective polarizer 121 and the first quarter wavelength plate 122 have a flat shape.

Since the first reflective polarizer 121 is attached to the first flat lens surface 123b of the first lens 123, an attaching apparatus able to attach a film-shaped optical element to a convex lens surface is not needed. Due to this, the cost required for equipment for manufacturing the optical system 102 is reduced. In addition, since the first reflective polarizer 121 is attached to the first flat lens surface 123b, problems such as air bubbles being trapped between the first reflective polarizer 121 and the first lens 123 and the first reflective polarizer 121 being wrinkled, sagged, or the like are unlikely to occur. Thus, the yield of the optical system 102 is raised and the cost required to manufacture the optical system 102 is lowered.

Since both the first reflective polarizer 121 and the first quarter wavelength plate 122 are attached to the first lens 123, the first reflective polarizer 121 and the first quarter wavelength plate 122 can be attached to the first lens 123 simply by attaching a layered body of the first reflective polarizer 121 and the first quarter wavelength plate 122 to the first lens 123. The layered body can be easily manufactured. Thus, it is possible to reduce the cost required for attaching the first reflective polarizer 121 and the first quarter wavelength plate 122 to the first lens 123.

Since the first lens 123 is a plano-convex lens, the cost of a mold required for manufacturing the first lens 123 can be lowered as compared with a case where the first lens 123 is a biconvex lens.

### 3.5 Second At Least One Optical Element

As illustrated in FIGS. 2 and 3, the second at least one optical element 114 includes the second reflective polarizer 131, a second quarter wavelength plate 132, and the second lens 133.

The second reflective polarizer 131 is a second film-shaped optical element. The second reflective polarizer 131 has a first main surface 131a and a second main surface 131b. The first main surface 131a and the second main surface 131b are present on mutually opposite sides. The second main surface 131b is the sixth surface 1146 of the second at least one optical element 114.

As illustrated in FIG. 4, the second reflective polarizer 131 has a second transmission axis 131c and a second reflection axis 131d. The second transmission axis 131c and the second reflection axis 131d are perpendicular to each other. The first polarization direction D1 is parallel to the second reflection axis 131d. The second polarization direction D2 is parallel to the second transmission axis 131c. Thus, the second reflective polarizer 131 selectively reflects linearly-polarized light 185q having the first polarization direction D1 and emits linearly-polarized light 186q having the first polarization direction D1. Further, the second reflective polarizer 131 selectively transmits linearly-polarized light 189p and 189q having the second polarization direction D2 and emits the linearly-polarized light 190p and 190q having the second polarization direction D2.

The second transmission axis 131c of the second reflective polarizer 131 is perpendicular to the first transmission axis 121c of the first reflective polarizer 121. The second reflection axis 131d of the second reflective polarizer 131 is perpendicular to the first reflection axis 121d of the first reflective polarizer 121.

The second quarter wavelength plate 132 is disposed between the half mirror 112 and the second reflective polarizer 131.

The second quarter wavelength plate 132 has a first surface 132a and a second surface 132b. The first surface 132a and the second surface 132b are present on mutually opposite sides. The first surface 132a is the fifth surface 1145 of the second at least one optical element 114.

As illustrated in FIG. 5, the second quarter wavelength plate 132 has a second fast axis 132e and a second slow axis 132f. The second fast axis 132e and the second slow axis 132f are perpendicular to each other. The first polarization direction D1 forms an angle of 45° with the second fast axis 132e. The second polarization direction D2 forms an angle of 45° with the second fast axis 132e. The second fast axis 132e is perpendicular to the first fast axis 122e of the first quarter wavelength plate 122. The second slow axis 132f is perpendicular to the first slow axis 122f of the first quarter wavelength plate 122. Thus, the second quarter wavelength plate 132 transmits the circularly-polarized light 184q having the first rotation direction DR and emits the linearly-polarized light 185q having the first polarization direction D1. The second quarter wavelength plate 132 transmits the linearly-polarized light 186q having the first polarization direction D1 and emits the circularly-polarized light 187q having the first rotation direction DR. Further, the second quarter wavelength plate 132 transmits the circularly-polarized light 188p and 188q having the second rotation direction DL and emits the linearly-polarized light 189p and 189q having the second polarization direction D2.

Thus, when the circularly-polarized light 184q having the first rotation direction DR is incident on the fifth surface 1145, the second at least one optical element 114 reflects the incident circularly-polarized light 184q and emits the circularly-polarized light 187q having the first rotation direction DR from the fifth surface 1145. When the circularly-polarized light 188p and 188q having the second rotation direction DL is incident on the fifth surface 1145, the second at least one optical element 114 transmits the incident circularly-polarized light 188p and 188q and emits the linearly-polarized light 190p and 190q having the second polarization direction D2 from the sixth surface 1146.

The second lens 133 is a second plano-convex lens. Due to this, the second lens 133 has positive power. The second lens 133 has the second convex lens surface 133a and a second flat lens surface 133b. The second convex lens surface 133a and the second flat lens surface 133b are present on mutually opposite sides. The second convex lens surface 133a faces the second surface 112b of the half mirror 112. The second convex lens surface 133a may take any of a spherical surface, an aspherical surface, and a free-form surface.

The second reflective polarizer 131 and the second quarter wavelength plate 132 are attached to the second flat lens surface 133b of the second lens 133 as a second plane. With this, the second reflective polarizer 131 and the second quarter wavelength plate 132 have a flat shape.

Since the second reflective polarizer 131 is attached to the second flat lens surface 133b of the second lens 133, an attaching apparatus able to attach a film-shaped optical element to a convex lens surface is not needed. Due to this, the cost required for equipment for manufacturing the optical system 102 is reduced. In addition, since the second reflective polarizer 131 is attached to the second flat lens surface 133b, problems such as air bubbles being trapped between the second reflective polarizer 131 and the second lens 133 and the second reflective polarizer 131 being wrinkled, sagged, or the like are unlikely to occur. Thus, the yield of the optical system 102 is raised and the cost required to manufacture the optical system 102 is lowered.

Since both the second reflective polarizer 131 and the second quarter wavelength plate 132 are attached to the second lens 133, the second reflective polarizer 131 and the second quarter wavelength plate 132 can be attached to the second lens 133 simply by attaching a layered body of the second reflective polarizer 131 and the second quarter wavelength plate 132 to the second lens 133. The layered body can be easily manufactured. Thus, it is possible to reduce the cost required for attaching the second reflective polarizer 131 and the second quarter wavelength plate 132 to the second lens 133.

The second lens 133 is disposed at a symmetric position to a position at which the first lens 123 is disposed with respect to the half mirror 112. The second lens 133 has a symmetric shape to a shape of the first lens 123 with respect to the half mirror 112. This makes it possible to suppress a situation in which the image formed by the optical system 102 becomes a double image.

### 3.6 Thinning of Optical System and Miniaturization of Display Device and Head-Mounted Device

In the display device 12, part of light emitted by the display 101 reciprocates between the half mirror 112 and the first reflective polarizer 121. In addition, part of the light emitted by the display 101 reciprocates between the half mirror 112 and the second reflective polarizer 131. Accordingly, the optical system 102 is a folded optical system. This makes it possible to lengthen an optical path of the light. Thus, the optical system 102 can be made to be a thin pancake lens. Accordingly, it is possible to reduce the size of the display device 12 and the head-mounted device 1 including the optical system 102.

In recent years, a virtual space called metaverse has been attracting attention. Because of this, as a tool for accessing a world constructed in the virtual space, a head-mounted device configured to provide a VR image is expected to be widespread. One of the causes of preventing the widespread use of head-mounted devices for providing VR contents is a large size of a housing of the head-mounted device. Therefore, the head-mounted device 1 capable of being miniaturized may resolve the above one of the causes.

### 3.7 Power and FOV of Optical System

In order to attach the first reflective polarizer 121 and the second reflective polarizer 131 to planes, the first lens 123 and the second lens 133 are formed to be plano-convex lenses.

In the case where the first lens 123 and the second lens 133 are plano-convex lenses, the positive powers of the first lens 123 and the second lens 133 are smaller and the positive power of the optical system 102 is smaller than in a case where the first lens 123 and the second lens 133 are biconvex lenses.

The convex lens 116 increases the positive power of the optical system 102. Therefore, the convex lens 116 compensates for the decrease in the positive power of the first lens 123 and the second lens 133. Thus, the positive power of the optical system 102 may be increased.

### 3.8 Convex Lens

The convex lens 116 is a third plano-convex lens. Due to this, the convex lens 116 has the third flat lens surface 116a and a third convex lens surface 116b. The third flat lens surface 116a and the third convex lens surface 116b are present on mutually opposite sides. The third flat lens surface 116a faces the second flat lens surface 133b of the second lens 133. The third convex lens surface 116b may take any of a spherical surface, an aspherical surface, and a free-form surface.

The second reflective polarizer 131 and the second quarter wavelength plate 132 may be attached to the third flat lens surface 116a as the second plane.

Since the convex lens 116 is a plano-convex lens, the cost of a mold required for manufacturing the convex lens 116 can be lowered as compared with a case where the convex lens 116 is a biconvex lens.

### 4. Second Embodiment

Hereinafter, differences of a second embodiment from the first embodiment will be described. For points that are not described, a configuration similar to the configuration employed in the first embodiment is also employed in the second embodiment.

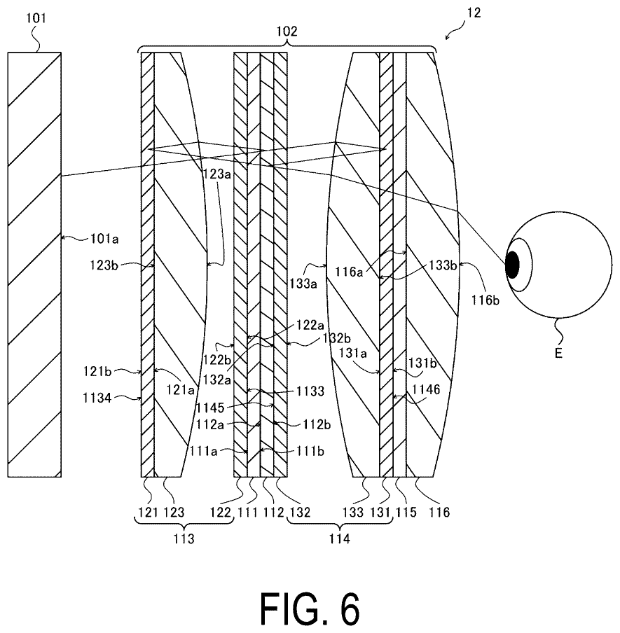

FIG. 6 is a cross-sectional view schematically illustrating a display device included in a head-mounted device according to the second embodiment.

In the second embodiment, as illustrated in FIG. 6, a first quarter wavelength plate 122 is attached to one main surface 111a of a transparent plate 111. A second quarter wavelength plate 132 is attached to the other main surface 111b of the transparent plate 111.

The accuracy of the polarization compensation performed by the first quarter wavelength plate 122 and the second quarter wavelength plate 132 can be enhanced by attaching the first quarter wavelength plate 122 and the second quarter wavelength plate 132 onto a common element, which is the transparent plate 111.

### 5. Third Embodiment

Hereinafter, differences of a third embodiment from the first embodiment will be described. For points that are not described, a configuration similar to the configuration employed in the first embodiment is also employed in the third embodiment.

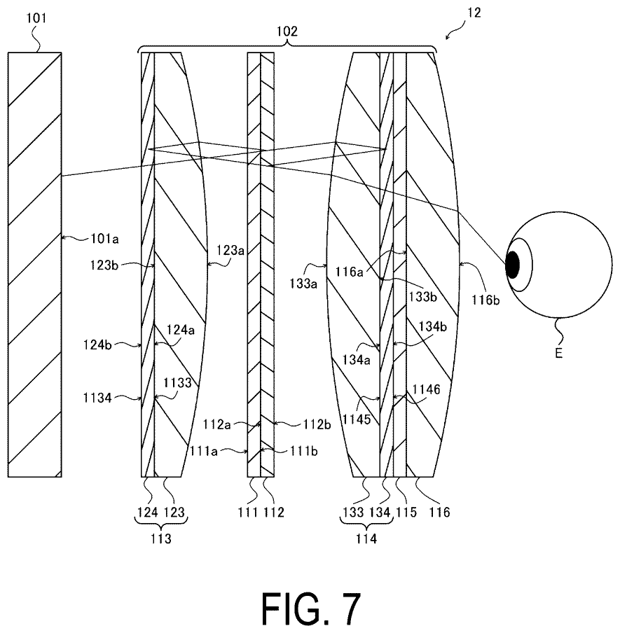

FIG. 7 is a cross-sectional view schematically illustrating a display device included in a head-mounted device according to the third embodiment.

In the third embodiment, as illustrated in FIG. 7, a first at least one optical element 113 includes a first cholesteric liquid crystal film 124 instead of the combination of the first reflective polarizer 121 and the first quarter wavelength plate 122. Further, a second at least one optical element 114 includes a second cholesteric liquid crystal film 134 instead of the combination of the second reflective polarizer 131 and the second quarter wavelength plate 132.

The combination of a reflective polarizer and a quarter wavelength plate has a property of selectively reflecting circularly-polarized light having a specific rotation direction and emitting circularly-polarized light having the specific rotation direction. A cholesteric liquid crystal film also has a property of selectively reflecting circularly-polarized light having a specific rotation direction and emitting circularly-polarized light having the specific rotation direction. Therefore, the cholesteric liquid crystal film can be used as an alternative to the combination of a reflective polarizer and a quarter wavelength plate.

The first cholesteric liquid crystal film 124 is a first film-shaped optical element attached to a first flat lens surface 123b of a first lens 123 as a first plane. The first cholesteric liquid crystal film 124 has a first main surface 124a and a second main surface 124b. The first main surface 124a and the second main surface 124b are present on mutually opposite sides. The first main surface 124a is a third surface 1133 of the first at least one optical element 113. The second main surface 124b is a fourth surface 1134 of the first at least one optical element 113.

The second cholesteric liquid crystal film 134 is a second film-shaped optical element attached to a third flat lens surface 133b of a second lens 133 as a second plane. The second cholesteric liquid crystal film 134 has a first main surface 134a and a second main surface 134b. The first main surface 134a and the second main surface 134b are present on mutually opposite sides. The first main surface 134a is a fifth surface 1145 of the second at least one optical element 114. The second main surface 134b is a sixth surface 1146 of the second at least one optical element 114.

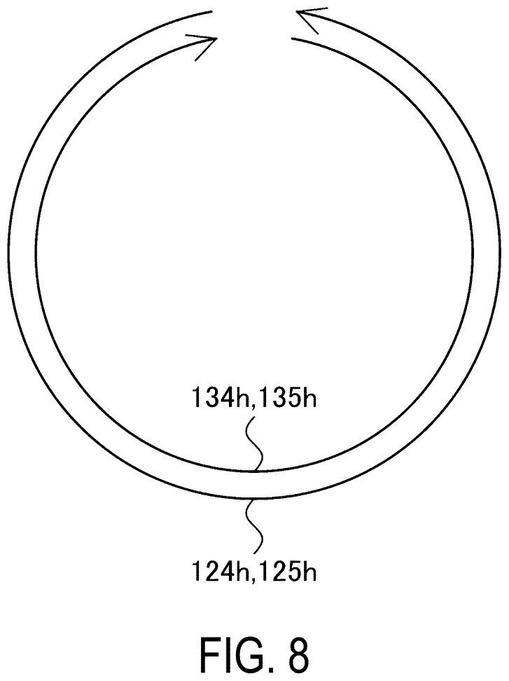

FIG. 8 is a diagram illustrating a relationship between a first turning direction of the first cholesteric liquid crystal film included in the head-mounted device and a second turning direction of the second cholesteric liquid crystal film included in the head-mounted device according to the third embodiment.

As illustrated in FIG. 8, the first cholesteric liquid crystal film 124 has a first turning direction 124h. Liquid crystal molecules contained in the first cholesteric liquid crystal film 124 have a structure in which the molecules spirally turn in the first turning direction 124h. The second rotation direction DL is the same direction as the first turning direction 124h. Thus, the first cholesteric liquid crystal film 124 selectively reflects the circularly-polarized light 184p having the second rotation direction DL.

The second cholesteric liquid crystal film 134 has a second turning direction 134h opposite to the first turning direction 124h. Liquid crystal molecules contained in the second cholesteric liquid crystal film 134 have a structure in which the molecules spirally turn in the second turning direction 134h. The first rotation direction DR is the same direction as the second turning direction 134h. Thus, the second cholesteric liquid crystal film 134 selectively reflects the circularly-polarized light 184q having the first rotation direction DR.

### 6. Fourth Embodiment

Hereinafter, differences of a fourth embodiment from the first embodiment will be described. For points that are not described, a configuration similar to the configuration employed in the first embodiment is also employed in the fourth embodiment.

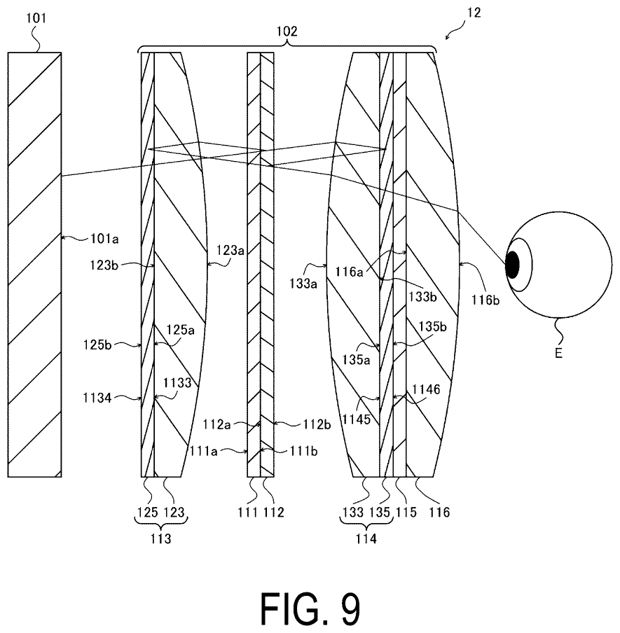

FIG. 9 is a cross-sectional view schematically illustrating a display device included in a head-mounted device according to the fourth embodiment.

In the fourth embodiment, as illustrated in FIG. 9, a first at least one optical element 113 includes a first polarized volume hologram (PVH) film 125 instead of the combination of the first reflective polarizer 121 and the first quarter wavelength plate 122. Further, a second at least one optical element 114 includes a second PVH film 135 instead of the combination of the second reflective polarizer 131 and the second quarter wavelength plate 132.

The combination of a reflective polarizer and a quarter wavelength plate has a property of selectively reflecting circularly-polarized light having a specific rotation direction and emitting circularly-polarized light having the specific rotation direction. A PVH film also has a property of selectively reflecting circularly-polarized light having a specific rotation direction and emitting circularly-polarized light having the specific rotation direction. Therefore, the PVH film can be used as an alternative to the combination of a reflective polarizer and a quarter wavelength plate.

The PVH film includes a large number of cholesteric liquid crystal molecules. The large number of cholesteric liquid crystal molecules are arrayed in a direction inclined from a plane direction of the PVH film. Thus, the PVH film can bend an optical path of circularly-polarized light having a specific rotation direction and can non-axially reflect or non-axially transmit the circularly-polarized light, and can transmit circularly-polarized light having a rotation direction opposite to the specific rotation direction. Non-axially reflecting light means that, when the light is specularly reflected, the reflected light is made to travel in a direction different from a direction in which the reflection light travels.

The first PVH film 125 is a first film-shaped optical element attached to a first flat lens surface 123b of a first lens 123 as a first plane. The first PVH film 125 has a first main surface 125a and a second main surface 125b. The first main surface 125a and the second main surface 125b are present on mutually opposite sides. The first main surface 125a is a third surface 1133 of the first at least one optical element 113. The second main surface 125b is a fourth surface 1134 of the first at least one optical element 113.

The second PVH film 135 is a second film-shaped optical element attached to a third flat lens surface 133b of a second lens 133 as a second plane. The second PVH film 135 has a first main surface 135a and a second main surface 135b. The first main surface 135a and the second main surface 135b are present on mutually opposite sides. The first main surface 135a is a fifth surface 1145 of the second at least one optical element 114. The second main surface 135b is a sixth surface 1146 of the second at least one optical element 114.

FIG. 8 is a diagram illustrating a relationship between a first turning direction of the first PVH film included in the head-mounted device and a second turning direction of the second PVH film included in the head-mounted device according to the fourth embodiment.

The first PVH film 125 has a first turning direction 125h. Liquid crystal molecules contained in the first PVH film 125 have a structure in which the molecules spirally turn in the first turning direction 125h. The second rotation direction DL is the same direction as the first turning direction 125h. Thus, the first PVH film 125 selectively reflects the circularly-polarized light 184p having the second rotation direction DL.

The second PVH film 135 has a second turning direction 135h opposite to the first turning direction 125h. Liquid crystal molecules contained in the second PVH film 135 have a structure in which the molecules spirally turn in the second turning direction 135h. The first rotation direction DR is the same direction as the second turning direction 135h. Thus, the second PVH film 135 selectively reflects the circularly-polarized light 184q having the first rotation direction DR.

Preferably, the direction in which the large number of cholesteric liquid crystal molecules included in each of the first PVH film 125 and the second PVH film 135 are arrayed is changed in a plane of each PVH film in such a manner that each PVH film has positive power like a concave mirror. With this, positive power can be imparted to each PVH film having a flat shape. This makes it possible to increase the positive power of the optical system 102, and thin the optical system 102.

### 7. Fifth Embodiment

Hereinafter, differences of a fifth embodiment from the first embodiment will be described. For points that are not described, a configuration similar to the configuration employed in the first embodiment is also employed in the fifth embodiment.

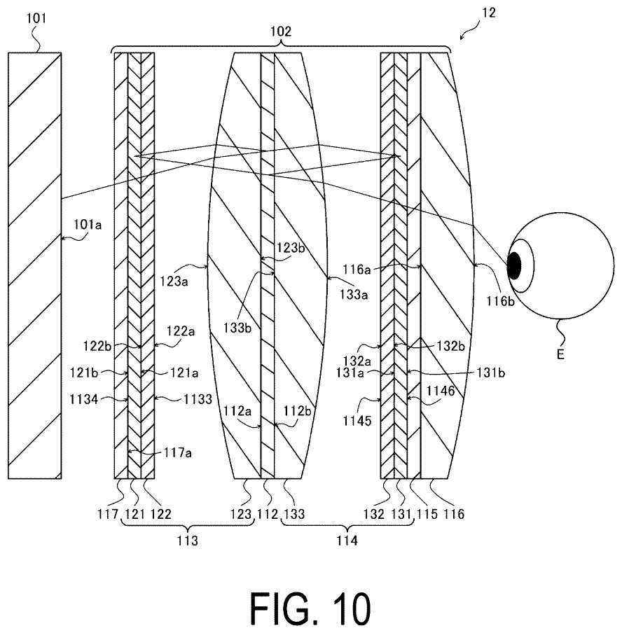

FIG. 10 is a cross-sectional view schematically illustrating a display device included in a head-mounted device according to the fifth embodiment.

In the fifth embodiment, as illustrated in FIG. 10, an optical system 102 includes a transparent plate 117.

The transparent plate 117 has a main surface 117a.

The transparent plate 117 is a glass plate or the like.

A first flat lens surface 123b of a first lens 123 faces a first surface 112a of a half mirror 112. The first lens 123 is disposed between the transparent plate 117 and the half mirror 112.

A second flat lens surface 133b of a second lens 133 faces a second surface 112b of the half mirror 112.

The half mirror 112 is sandwiched between the first flat lens surface 123b of the first lens 123 and the second flat lens surface 133b of the second lens 133. The half mirror 112 is prepared in the following manner: for example, a metal is deposited on the flat lens surface of one of the first lens 123 and the second lens 133 to prepare a composite of the one of the first lens 123 and second lens 133 and the half mirror 112, and then the prepared composite is bonded to the other one of the first lens 123 and the second lens 133. The bonding between the composite and the other one of the first lens 123 and the second lens 133 is carried out in such a manner that the first lens 123 and the second lens 133 are symmetric with respect to the half mirror 112. An adhesive or the like is selected in such a manner that the symmetry is not substantially lost even when a distance from the half mirror 112 to the second lens 133 is different from a distance from the half mirror 112 to the first lens 123 due to the adhesive or the like. The fifth embodiment is adopted in a case where a composite as a rigid body and the other one of the first lens 123 and the second lens 133 as a rigid body can be bonded to each other with an adhesive or the like.

A first reflective polarizer 121 and a first quarter wavelength plate 122 are attached to the main surface 117a of the transparent plate 117 as a first plane.

A second reflective polarizer 131 and a second quarter wavelength plate 132 are attached to a third flat lens surface 116a of a convex lens 116 as a second plane.

### 8. Sixth Embodiment

Hereinafter, differences of a sixth embodiment from the fifth embodiment will be described. For points that are not described, a configuration similar to the configuration employed in the fifth embodiment is also employed in the sixth embodiment.

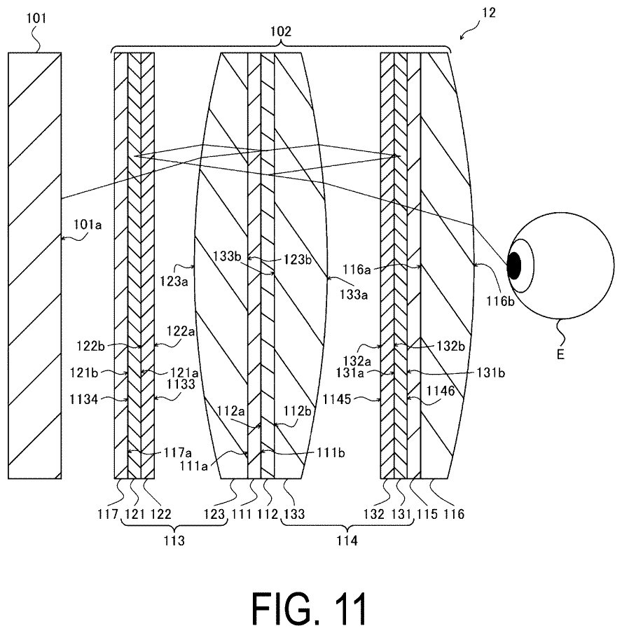

FIG. 11 is a cross-sectional view schematically illustrating a display device included in a head-mounted device according to the sixth embodiment.

In the sixth embodiment, as illustrated in FIG. 11, an optical system 102 includes a transparent plate 111.

Thus, the optical system 102 includes a transparent plate 117 as a first transparent plate and the transparent plate 111 as a second transparent plate. The transparent plate 117 has a main surface 117a as a first main surface, and the transparent plate 111 has the other main surface 111b as a second main surface.

The transparent plate 111 is disposed between a first flat lens surface 123b of a first lens 123 and a second flat lens surface 133b of a second lens 133.

A half mirror 112 is disposed on the other main surface 111b of the transparent plate 111.

By attaching the half mirror 112 onto the other main surface 111b of the transparent plate 111, it is possible to increase the flatness of the half mirror 112, which plays an important role in the display device 12 employing the double pass method.

### 9. Seventh Embodiment

Hereinafter, differences of a seventh embodiment from the fifth embodiment will be described. For points that are not described, a configuration similar to the configuration employed in the fifth embodiment is also employed in the seventh embodiment.

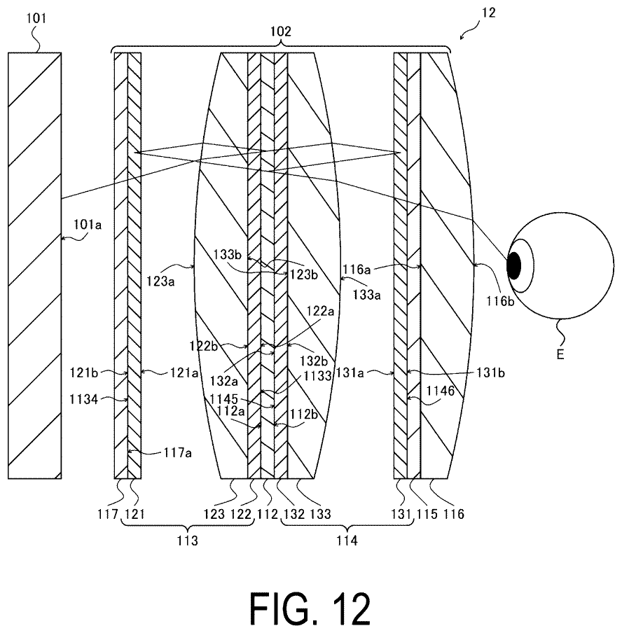

FIG. 12 is a cross-sectional view schematically illustrating a display device included in a head-mounted device according to the seventh embodiment.

In the seventh embodiment, as illustrated in FIG. 12, a first quarter wavelength plate 122 is attached to a first flat lens surface 123b of a first lens 123. A second quarter wavelength plate 132 is attached to a second flat lens surface 133b of a second lens 133. A half mirror 112 is sandwiched between the first quarter wavelength plate 122 and the second quarter wavelength plate 132.

The accuracy of the polarization compensation performed by the first quarter wavelength plate 122 and the second quarter wavelength plate 132 can be enhanced by attaching the first quarter wavelength plate 122 and the second quarter wavelength plate 132 onto a common element, which is the half mirror 112.

The seventh embodiment is employed in a case where the half mirror 112 can be disposed on the first quarter wavelength plate 122 or the second quarter wavelength plate 132.

### 10. Eighth Embodiment

Hereinafter, differences of an eighth embodiment from the fifth embodiment will be described. For points that are not described, a configuration similar to the configuration employed in the fifth embodiment is also employed in the eighth embodiment.

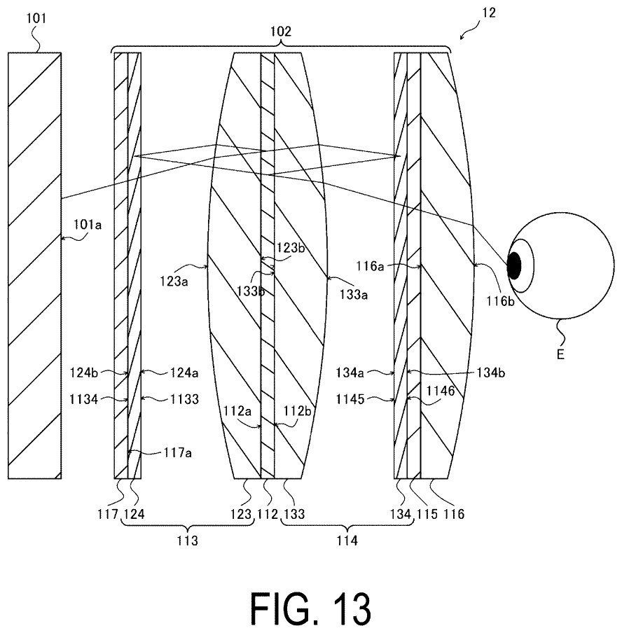

FIG. 13 is a cross-sectional view schematically illustrating a display device included in a head-mounted device according to the eighth embodiment.

In the eighth embodiment, as illustrated in FIG. 13, a first at least one optical element 113 includes a first cholesteric liquid crystal film 124 instead of the combination of the first reflective polarizer 121 and the first quarter wavelength plate 122. Further, a second at least one optical element 114 includes a second cholesteric liquid crystal film 134 instead of the combination of the second reflective polarizer 131 and the second quarter wavelength plate 132. The first cholesteric liquid crystal film 124 and the second cholesteric liquid crystal film 134 in the eighth embodiment are cholesteric liquid crystal films similar to the first cholesteric liquid crystal film 124 and the second cholesteric liquid crystal film 134 in the third embodiment, respectively.

### 11. Ninth Embodiment

Hereinafter, differences of a ninth embodiment from the fifth embodiment will be described. For points that are not described, a configuration similar to the configuration employed in the fifth embodiment is also employed in the ninth embodiment.

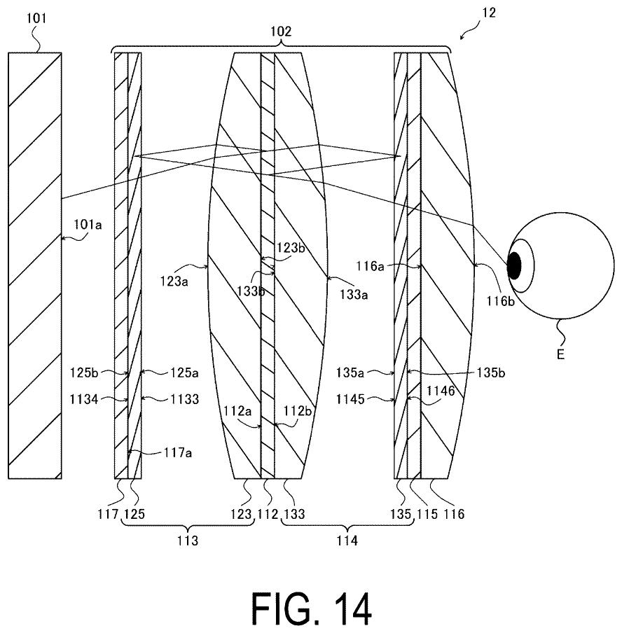

FIG. 14 is a cross-sectional view schematically illustrating a display device included in a head-mounted device according to the ninth embodiment.

In the ninth embodiment, as illustrated in FIG. 14, a first at least one optical element 113 includes a first PVH film 125 instead of the combination of the first reflective polarizer 121 and the first quarter wavelength plate 122. Further, a second at least one optical element 114 includes a second PVH film 135 instead of the combination of the second reflective polarizer 131 and the second quarter wavelength plate 132. The first PVH film 125 and the second PVH film 135 in the ninth embodiment are PVH films similar to the first PVH film 125 and the second PVH film 135 in the fourth embodiment, respectively.

The disclosure is not limited to the embodiments described above, and may be substituted with a configuration that is substantially the same as the configuration described in the embodiments described above, a configuration that achieves the same action and effect, or a configuration capable of achieving the same object.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An optical system, comprising:
a half mirror having a first surface and a second surface on mutually opposite sides;
a first at least one optical element that includes a first film-shaped optical element to be attached to a first plane and has a third surface and a fourth surface on mutually opposite sides, the third surface facing the first surface, first circularly-polarized light having a first rotation direction being emitted from the third surface in a case where first linearly-polarized light having a first polarization direction is incident on the fourth surface, third circularly-polarized light having a second rotation direction being emitted from the third surface in a case where second circularly-polarized light having the second rotation direction different from the first rotation direction is incident on the third surface;
a second at least one optical element that is disposed at a symmetric position to a position at which the first at least one optical element is disposed with respect to the half mirror, has a symmetric shape to a shape of the first at least one optical element with respect to the half mirror, includes a second film-shaped optical element to be attached to a second plane, and has a fifth surface and a sixth surface on mutually opposite sides, the fifth surface facing the second surface, fifth circularly-polarized light having the first polarization direction being emitted from the fifth surface in a case where fourth circularly-polarized light having the first rotation direction is incident on the fifth surface, second linearly-polarized light having a second polarization direction perpendicular to the first polarization direction being emitted from the sixth surface in a case where sixth circularly-polarized light having the second rotation direction is incident on the fifth surface; and
a convex lens configured to transmit the second linearly-polarized light.

2. The optical system according to claim 1,
wherein the first at least one optical element includes a first lens, and
the second at least one optical element includes a second lens that is disposed at a symmetric position to a position at which the first lens is disposed with respect to the half mirror and has a symmetric shape to a shape of the first lens with respect to the half mirror.

3. The optical system according to claim 2,
wherein the first lens is a first plano-convex lens having a first flat lens surface and a first convex lens surface on mutually opposite sides, and
the second lens is a second plano-convex lens having a second flat lens surface and a second convex lens surface on mutually opposite sides.

4. The optical system according to claim 3,
wherein the first convex lens surface faces the first surface,
the second convex lens surface faces the second surface,
the first plane is the first flat lens surface, and
the second plane is the second flat lens surface, wherein
the optical system further comprises:
a transparent plate having a main surface and disposed between the first convex lens surface and the second convex lens surface,
wherein the half mirror is disposed on the main surface.

5. The optical system according to claim 3,
wherein the first convex lens surface faces the first surface,
the second convex lens surface faces the second surface,
the convex lens is a third plano-convex lens having a third flat lens surface and a third convex lens surface on mutually opposite sides, the third flat lens surface facing the second flat lens surface,
the first plane is the first flat lens surface, and
the second plane is the third flat lens surface, wherein
the optical system further comprises:
a transparent plate having a main surface and disposed between the first convex lens surface and the second convex lens surface, wherein
the half mirror is disposed on the main surface.

6. The optical system according to claim 3, further comprising:
a transparent plate having a main surface, wherein
the first plano-convex lens is disposed between the transparent plate and the half mirror,
the first flat lens surface faces the first surface,
the second flat lens surface faces the second surface,
the convex lens is a third plano-convex lens having a third flat lens surface and a third convex lens surface on mutually opposite sides, the third flat lens surface facing the second convex lens surface,
the first plane is the main surface, and
the second plane is the third flat lens surface.

7. The optical system according to claim 6,
wherein the half mirror is sandwiched between the first flat lens surface and the second flat lens surface.

8. The optical system according to claim 6,
wherein the transparent plate is a first transparent plate,
the main surface is a first main surface,
the optical system further includes a second transparent plate having a second main surface and disposed between the first flat lens surface and the second flat lens surface, and
the half mirror is disposed on the second main surface.

9. The optical system according to claim 1,
wherein the first film-shaped optical element is a first reflective polarizer having the fourth surface and having a first transmission axis and a first reflection axis,
the first at least one optical element includes a first quarter wavelength plate that is disposed between the half mirror and the first reflective polarizer, has the third surface, and has a first fast axis and a first slow axis,
the second film-shaped optical element is a second reflective polarizer having the sixth surface, and having a second transmission axis and a second reflection axis, the second transmission axis being perpendicular to the first transmission axis and the second reflection axis being perpendicular to the first reflection axis, and
the second at least one optical element includes a second quarter wavelength plate disposed between the half mirror and the second reflective polarizer, having the fifth surface, and having a second fast axis and a second slow axis, the second fast axis being perpendicular to the first fast axis and the second slow axis being perpendicular to the first slow axis.

10. The optical system according to claim 9,
wherein the first at least one optical element includes a first plano-convex lens having a first flat lens surface and a first convex lens surface on mutually opposite sides, the first convex lens surface facing the first surface,
the second at least one optical element includes a second plano-convex lens having a second flat lens surface and a second convex lens surface on mutually opposite sides, the second convex lens surface facing the second surface,
the first plane is the first flat lens surface,
the second plane is the second flat lens surface,
the first quarter wavelength plate is attached to the first flat lens surface, and
the second quarter wavelength plate is attached to the second flat lens surface.

11. The optical system according to claim 9,
wherein the first at least one optical element includes a first plano-convex lens having a first flat lens surface and a first convex lens surface on mutually opposite sides, the first convex lens surface facing the first surface,
the second at least one optical element includes a second plano-convex lens having a second flat lens surface and a second convex lens surface on mutually opposite sides, the second convex lens surface facing the second surface,
the convex lens is a third plano-convex lens having a third flat lens surface and a third convex lens surface on mutually opposite sides, the third flat lens surface facing the second flat lens surface,
the first plane is the first flat lens surface,
the second plane is the third flat lens surface,
the first quarter wavelength plate is attached to the first flat lens surface, and
the second quarter wavelength plate is attached to the third flat lens surface.

12. The optical system according to claim 9,
wherein the first at least one optical element includes a first plano-convex lens having a first flat lens surface and a first convex lens surface on mutually opposite sides, the first convex lens surface facing the first surface,
the second at least one optical element includes a second plano-convex lens having a second flat lens surface and a second convex lens surface on mutually opposite sides, the second convex lens surface facing the second surface,
the optical system further includes a transparent plate having one main surface and the other main surface on mutually opposite sides, and disposed between the first convex lens surface and the second convex lens surface,
the first plane is the first flat lens surface,
the second plane is the second flat lens surface,
the first quarter wavelength plate is attached to the one main surface,
the second quarter wavelength plate is attached to the other main surface, and
the half mirror is disposed on the one main surface or on the other main surface.

13. The optical system according to claim 9,
wherein the first at least one optical element includes a first plano-convex lens having a first flat lens surface and a first convex lens surface on mutually opposite sides, the first convex lens surface facing the first surface,
the second at least one optical element includes a second plano-convex lens having a second flat lens surface and a second convex lens surface on mutually opposite sides, the second convex lens surface facing the second surface,
the convex lens is a third plano-convex lens having a third flat lens surface and a third convex lens surface on mutually opposite sides, the third flat lens surface facing the second flat lens surface,
the optical system further includes a transparent plate having one main surface and the other main surface on mutually opposite sides, and disposed between the first convex lens surface and the second convex lens surface,
the first plane is the first flat lens surface,
the second plane is the third flat lens surface,
the first quarter wavelength plate is attached to the one main surface,
the second quarter wavelength plate is attached to the other main surface, and
the half mirror is disposed on the one main surface or on the other main surface.

14. The optical system according to claim 9, further comprising:
a transparent plate having a main surface, wherein,
the first at least one optical element includes a first plano-convex lens having a first flat lens surface and a first convex lens surface on mutually opposite sides, and disposed between the transparent plate and the half mirror, the first flat lens surface facing the first surface,
the second at least one optical element includes a second plano-convex lens having a second flat lens surface and a second convex lens surface on mutually opposite sides, the second flat lens surface facing the second surface,
the convex lens is a third plano-convex lens having a third flat lens surface and a third convex lens surface on mutually opposite sides, the third flat lens surface facing the second convex lens surface,
the first plane is the main surface,
the second plane is the third flat lens surface,
the first quarter wavelength plate is attached to the main surface,
the second quarter wavelength plate is attached to the third flat lens surface, and
the half mirror is sandwiched between the first flat lens surface and the second flat lens surface.

15. The optical system according to claim 9, further comprising:
a first transparent plate having a first main surface, and a second transparent plate having a second main surface, wherein,
the first at least one optical element includes a first plano-convex lens having a first flat lens surface and a first convex lens surface on mutually opposite sides, and disposed between the first transparent plate and the half mirror, the first flat lens surface facing the first surface,
the second at least one optical element includes a second plano-convex lens having a second flat lens surface and a second convex lens surface on mutually opposite sides, the second flat lens surface facing the second surface,
the convex lens is a third plano-convex lens having a third flat lens surface and a third convex lens surface on mutually opposite sides, the third flat lens surface facing the second convex lens surface,
the second transparent plate is disposed between the first flat lens surface and the second flat lens surface,
the first plane is the first main surface,
the second plane is the third flat lens surface,
the first quarter wavelength plate is attached to the first main surface,
the second quarter wavelength plate is attached to the third flat lens surface, and
the half mirror is disposed on the second main surface.

16. The optical system according to claim 9, further comprising:
a transparent plate having a main surface, wherein,
the first at least one optical element includes a first plano-convex lens having a first flat lens surface and a first convex lens surface on mutually opposite sides, and disposed between the transparent plate and the half mirror, the first flat lens surface facing the first surface,
the second at least one optical element includes a second plano-convex lens having a second flat lens surface and a second convex lens surface on mutually opposite sides, the second flat lens surface facing the second surface,
the convex lens is a third plano-convex lens having a third flat lens surface and a third convex lens surface on mutually opposite sides, the third flat lens surface facing the second convex lens surface,
the first plane is the main surface,
the second plane is the third flat lens surface,
the first quarter wavelength plate is attached to the first flat lens surface,
the second quarter wavelength plate is attached to the second flat lens surface, and
the half mirror is sandwiched between the first quarter wavelength plate and the second quarter wavelength plate.

17. The optical system according to claim 1,
wherein the first film-shaped optical element is a first cholesteric liquid crystal film having the third and fourth surfaces and having a first turning direction, and
the second film-shaped optical element is a second cholesteric liquid crystal film having the fifth and sixth surfaces and having a second turning direction different from the first turning direction.

18. The optical system according to claim 1,
wherein the first film-shaped optical element is a first polarized volume hologram film having the third and fourth surfaces and having a first turning direction, and
the second film-shaped optical element is a second polarized volume hologram film having the fifth and sixth surfaces and having a second turning direction different from the first turning direction.

19. A display device, comprising:
the optical system according to claim 1; and
a display configured to emits the first linearly-polarized light.

20. A head-mounted device, comprising:
the display device according to claim 19.
